(19) United States
(12) Patent Application Publication
(10) Pub. No.: US 2010/0300852 A1
(43) Pub. Date: Dec. 2, 2010

(54) LOW-VOLTAGE, MEDIUM-VOLTAGE OR HIGH-VOLTAGE SWITCHGEAR ASSEMBLY WITH AT LEAST ONE MOVEABLE CONTACT

(75) Inventors: Dietmar Gentsch, Ratingen (DE); Christof Humpert, Willich (DE); Till Ruemenapp, Mettmann (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/795,093

(22) Filed: Jun. 7, 2010

Related U.S. Application Data
(63) Continuation of application No. PCT/EP2008/010260, filed on Dec. 4, 2008.

(30) Foreign Application Priority Data
Dec. 7, 2007 (EP) 07023713.6

(51) Int. Cl. H01H 9/00

(52) U.S. Cl. 200/238

(57) ABSTRACT

An exemplary switchgear assembly is disclosed with at least one moveable contact piece, in which the moveable contact is connected to a connection piece electrically with a flexible connection means. A connection between the connector strip and the connection piece of the pole part is provided. The connection can have relatively low electrical and thermal resistance. A flexible connection means is connected to the connection piece directly or with an intermediate piece, which can be connected to the connection piece, cohesively or at least unreleasably.

### RELATED APPLICATIONS

This application claims priority as a continuation application under 35 U.S.C. §120 to PCT/EP2008/010260, which was filed as an International Application on Dec. 4, 2008 designating the U.S., and which claims priority to European Application 07023713.6 filed in Europe on Dec. 7, 2007. The entire contents of these applications are hereby incorporated by reference in their entireties.

### FIELD

The disclosure relates to a low-voltage, medium-voltage or high-voltage switchgear assembly, such as assemblies with at least one moveable contact piece, in which the moveable contact is connected to a stationary connection piece electrically with a flexible connection means.

### BACKGROUND INFORMATION

Switching devices are known, in for example, the medium-voltage range. These switching devices can be equipped with so-called pole parts, in which vacuum interrupter chambers can be installed or cast in as actual switching elements.

The pole parts can have two stationary connection pieces, to which the switching device in the switchgear assembly can be connected to further components. The stationary connection pieces can be connected to the feed lines of the vacuum interrupter chamber within the pole part. This connection can be designed to be rigid on one side, for example, the fixed contact side. On the other side, for example, the switching contact side, the stationary connection piece of the pole part can be connected to the moveable feed line of the vacuum interrupter chamber in such a way that a relative movement of the moveable feed line is made possible. This can be achieved, for example, by a rolling contact, a multi-contact system or a connector strip. Connector strips are usually in the form of separate component parts, which also need to be fitted separately.

DE 9017054 U1 discloses a switch pole arrangement with a moveable connector strip. This document describes an arrangement of an open pole part, in which a vacuum interrupter chamber can be installed in the tubular pole part via corresponding mounts. The moveable feed line can be connected to the connection piece of the pole part, in this case in the form of a busbar, by a connector strip. The fixing of the connector strip in this case takes place by screws.

Ring-type connector strips are also known.

The sum of all the electrical resistances in the pole part can result, during operation with current flow, in heating of the pole part which should not exceed a specific temperature level (predetermined by standards and material properties). For this reason, reducing the total resistance of the pole part (greater conductor cross sections, material selection, optimization of the transfer resistances) can be desirable.

Connecting the connector strip to the connection piece of the pole part by screw connections can result in the connecting point having a relatively high electrical transfer resistance. This is brought about by the only partial surface contact of the connector strip and the connection piece in the region of the screw connection. Furthermore, the screwed connecting point can have a relatively high thermal resistance. Since the thermal energy which arises in the pole part is principally dissipated via the connection pieces and the conductors connected thereto, the screw connection not only can result in an increase in the thermal energy produced but also in a reduction in the thermal conduction and therefore overall in greater heating of the pole part.

### SUMMARY

A voltage switchgear assembly is disclosed comprising at least one moveable contact piece, and a connection piece electrically connected to the moveable contact piece with a flexible connecting means, wherein the flexible connecting means is cohesively connected to the connection piece.

A voltage switchgear assembly is disclosed comprising at least one moveable contact piece, and a connection piece electrically connected to the moveable contact piece with a flexible connecting means, wherein the flexible connecting means is cohesively connected to an intermediate piece which is cohesively connected to the connection piece.

### BRIEF DESCRIPTION OF THE DRAWINGS

The disclosure is illustrated in the drawings and described in more detail below.

FIG. 1 shows a first exemplary embodiment with an integrally formed connector strip;

FIG. 2 shows a second exemplary embodiment with a cylindrical connection piece;

FIG. 3 shows a side view of the installed state with respect to the second exemplary embodiment shown in FIG. 2;

FIG. 4 shows an exemplary embodiment as in FIGS. 2/3 with the central connection piece having a drilled hole;

FIG. 5 shows an exemplary embodiment with connector strips bent forward;

FIG. 6 shows an exemplary embodiment with connector strips bent forward in the form of a U;

FIG. 7 shows an exemplary embodiment with four bent connector strips; and

FIG. 8 shows an exemplary embodiment with a membrane as the electrical connecting element.

### DETAILED DESCRIPTION

The connection between a connector strip and a connection piece of a pole part which has an electrical and thermal resistance is disclosed which can be low while maintaining the mechanical properties of a known connector strip.

In the connector strip, a flexible connecting means is connected to a connection piece directly or with an intermediate piece, which can be connected to the connection piece, cohesively or at least unreleasably.

In the case of known designs, the connector strip between the contact piece feed line and the connection piece, can be a separate component part, which is fitted to the contact piece feed line of the contact piece, but also additionally is fitted to the connection piece. Releasable connections produce transfer resistances, however. As a result of the high potential current levels, a high power can be released via the transfer resistances, and this can result in a heat flow from the conductors.

In this case moreover the term connection piece is intended to reference a connection piece which runs through the pole part wall for an external contact to the outside.

In order to reduce thermal heating within the pole part, the transfer resistance between a connecting means, such as a connector strip and a connection piece can be reduced in a manner as disclosed herein. In this case, the connecting point may be a cohesive (e.g., a materially cohesive), transition between the connection piece and the connector strip.

A further exemplary configuration provides a connecting means integrally formed materially cohesively on the connection piece or on the intermediate piece in such a way that it forms, with the connection piece or the intermediate piece, an integral unit. This form can provide the least transfer resistance.

A further exemplary configuration provides that the connecting point between the connection piece and the connecting means, for example, the connector strip, can be a pressed or cast connection.

A further exemplary configuration provides that the connection piece can be a hollow-cylindrical metallic component part, in which the hollow cylinder can be parallel to the contact piece actuation axis and at least one connecting means can be arranged within the hollow cylinder and is connected to the hollow cylinder section integrally and materially cohesively or in pressed fashion.

A further exemplary configuration can include two connector strips that can be arranged on diametrically opposite sides and can be attached centrally one above the other to the contact piece feed line of the moveable contact piece.

In alternate embodiments, the connector strips can be designed to be flexible.

A further exemplary configuration can include connector strips that can be fitted in such a way that they are bent forwards in one direction. In this case, greater flexibility in the mechanical actuation excursion is made possible.

A special but likewise effective exemplary configuration includes four connector strips, in each case two diametrically positioned connector strips, arranged in such a way that they are bent forwards in one direction.

An exemplary embodiment includes a type of sheet membrane can be provided as the connecting means. The sheet membrane can be connected centrally with screws on the moveable contact pin and at the edge to the hollow-cylindrical section of the connection piece.

As a result of the configuration in which the sheet membrane is a concentrically corrugated membrane, increased flexibility when implementing the membrane can be achieved.

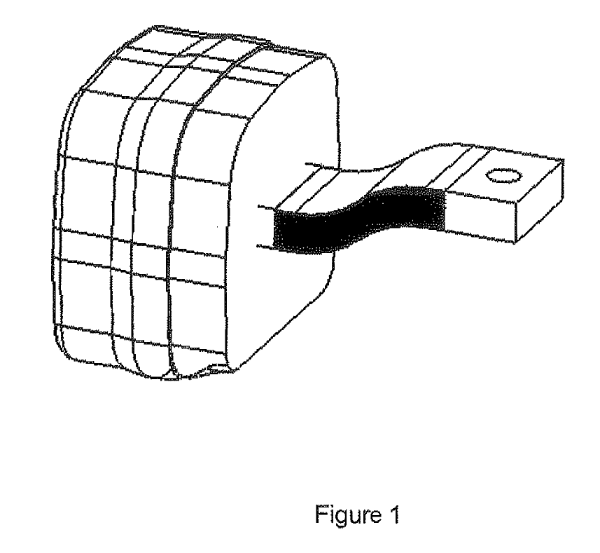

FIG. 1 shows a first exemplary embodiment, wherein the connector strip is connected cohesively to the connection piece. For example, one end of the connector strip can to be pressed or cast directly with the connection piece during warm-pressing or metal-casting of the connection piece. This results in an integral connection piece, in which the outer connection piece merges cohesively with the flexible electrical transition. As a result of this measure, the total resistance (electrical and thermal) can be reduced in comparison with a screw connection.

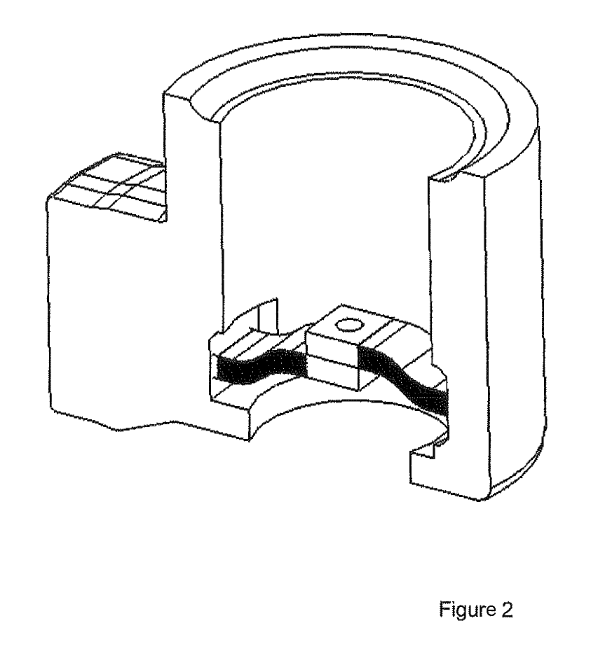

FIG. 2 shows a second exemplary embodiment, in which, in addition to the embodiment with a single connector strip, a plurality of connector strips can be cohesively connected to an approximately hollow-cylindrical connection piece. When arranging the connector strips care should be taken to ensure that the electrical resistances of the various electrical paths are substantially equal, so that the current can be split uniformly. This can take place by the cross sections of the flexible conductors or of subregions of the connection piece being adjusted.

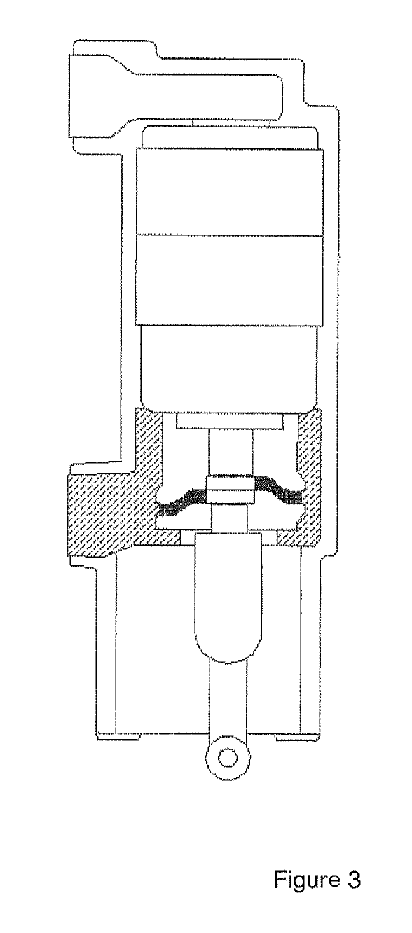

FIG. 3 shows the side view of the installed state of the exemplary embodiment with respect to FIG. 2.

In the previous embodiment, it has been assumed that the pressed or fused-in connector strips are known connector strips. The connection to the vacuum interrupter chamber then takes place via the existing drilled-through holes in the end faces of the connector strips by a pushed-through connection.

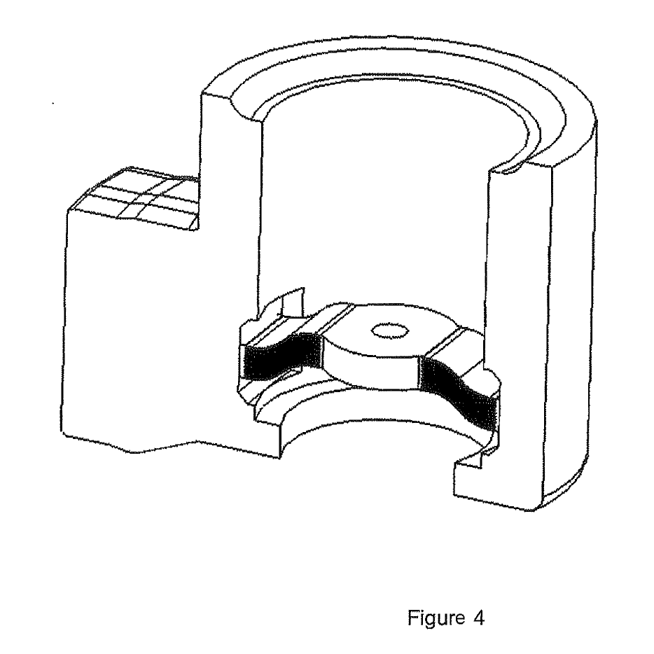

FIG. 4 shows a further exemplary embodiment, for example, using a special connector strip, in which two or more flexible conductors can be connected in the center to form a common plate. The connection can take place by means which implement various, known methods, for example, welding, diffusion welding or soldering.

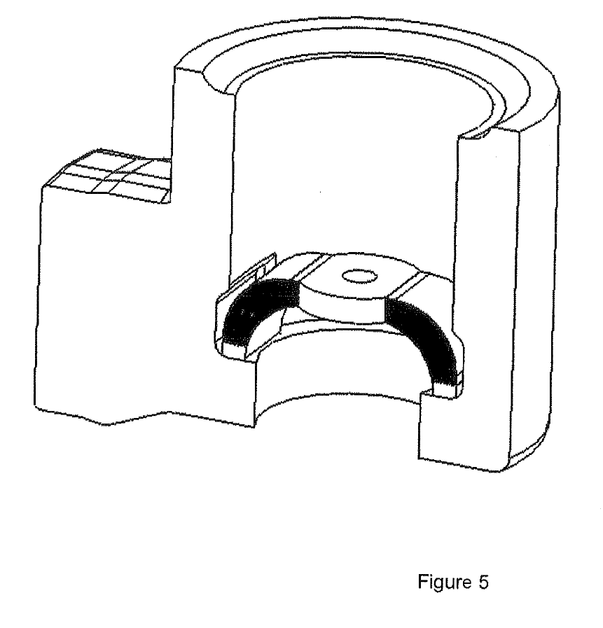

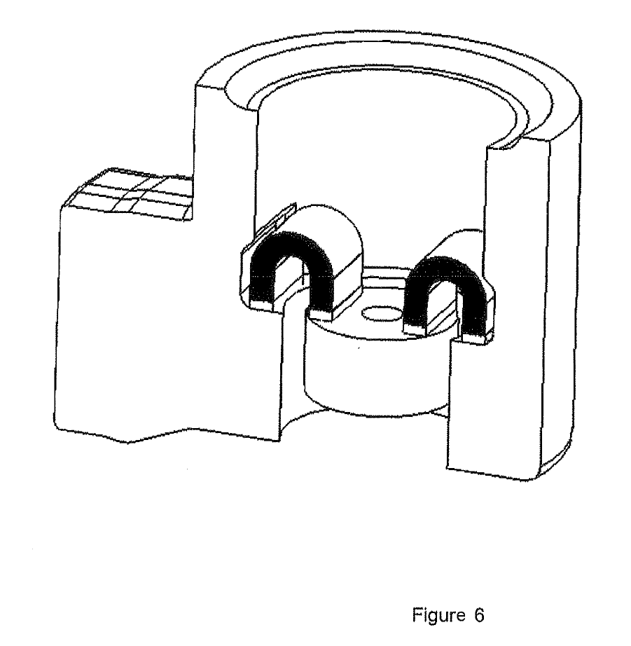

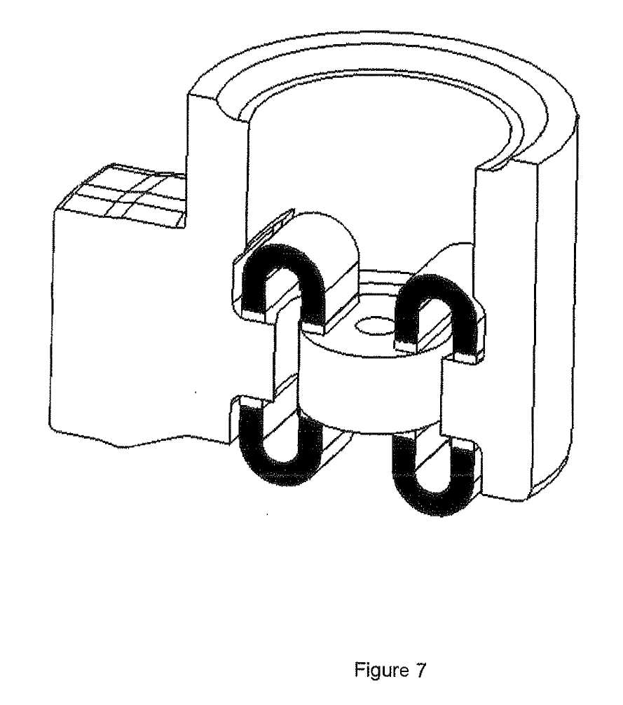

FIG. 6 shows a development of this concept in which, in one step, individual connector strips can be cohesively connected to the outer and one inner connection piece. The position and the number of the flexible connections used can be selected very differently. Exemplary embodiments are illustrated in FIGS. 5 and 7.

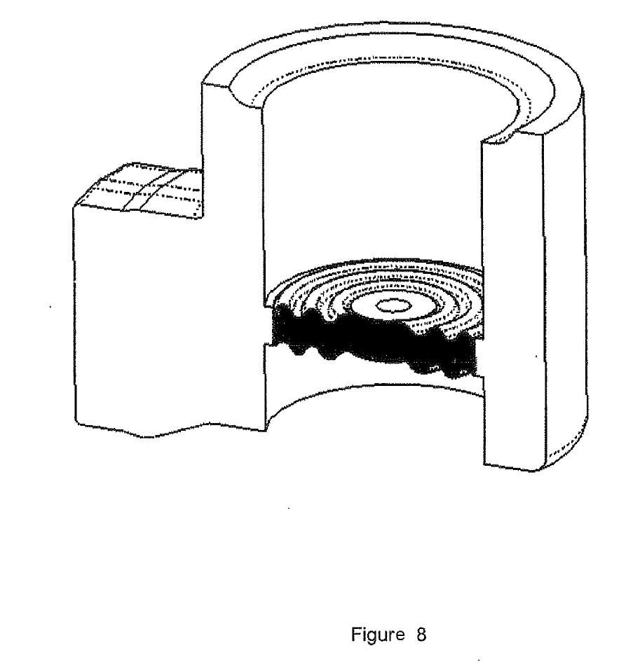

FIG. 8 shows a further exemplary embodiment of a basic concept in which the use of a sheet membrane or corrugated washer, which can, with a round embodiment, be attached to the entire inner circumference of the connection piece or is connected thereto in an interlocking manner.

As in the case of the connector strips, it can be desirable to place a large number of corrugated washers one above the other for sufficient current-carrying capacity. In an essentially air-tight embodiment shown, during switching, the compression or decompression of the air enclosed between the membrane and the vacuum interrupter chamber can result in damping of the switching process. This can lead to an optimized switching response of the circuit breaker as a result of the reduced rebound response or reverse response during opening of the contact pieces. In order to vary the damping, it is possible to provide the corrugated washers with defined openings (for example drilled holes) in order to produce targeted pressure compensation. In addition, the openings can contribute to the cooling of the current transfer as a result of the air exchange produced.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A voltage switchgear assembly comprising:
at least one moveable contact piece; and
a connection piece electrically connected to the moveable contact piece with a flexible connecting means, wherein
the flexible connecting means is cohesively connected to the connection piece.

2. The voltage switchgear assembly as claimed in claim 1, wherein
the flexible connecting means is integrally formed materially cohesively on the connection piece to form, with the connection piece, an integral unit.

3. The voltage switchgear assembly as claimed in claim 1, wherein
a connecting point between the connection piece and the connecting means is a pressed connection.

4. The voltage switchgear assembly as claimed in claim 1, wherein
the connection piece is a hollow-cylindrical metallic component part, in which the hollow cylinder is parallel to a contact actuation axis, and the connecting means is arranged within the hollow cylinder and is connected to the hollow cylinder integrally and materially cohesively.

5. The voltage switchgear assembly as claimed in claim 4, wherein the connecting means comprising:
two connector strips arranged on diametrically opposite sides, attached centrally one above the other to a contact piece feed line of the moveable contact.

6. The voltage switchgear assembly as claimed in claim 5, wherein
the connector strips are flexible.

7. The voltage switchgear assembly as claimed in claim 6, wherein
the connector strips are fitted such that they are bent forward in one direction.

8. The voltage switchgear assembly as claimed in claim 7, wherein
four connector strips, in each case two diametrically positioned connector strips, are each arranged such that they are bent forward in one direction.

9. The voltage switchgear assembly as claimed in claim 5, wherein the connecting means comprises:
a sheet-metal membrane connected centrally using screws on the moveable contact piece feed line and at an edge to a hollow-cylindrical section of the connection piece.

10. The voltage switchgear assembly as claimed in claim 9, wherein
the sheet-metal membrane is a concentrically corrugated membrane.

11. The voltage switchgear assembly as claimed in claim 1, wherein the voltage switchgear assembly is a low-voltage switch gear assembly.

12. The voltage switchgear assembly as claimed in claim 1, wherein the voltage switchgear assembly is a medium-voltage switch gear assembly.

13. The voltage switchgear assembly as claimed in claim 1, wherein the voltage switchgear assembly is a high-voltage switch gear assembly.

14. A voltage switchgear assembly comprising:
at least one moveable contact piece; and
a connection piece electrically connected to the moveable contact piece with a flexible connecting means, wherein
the flexible connecting means is cohesively connected to an intermediate piece which is cohesively connected to the connection piece.

15. The voltage switchgear assembly as claimed in claim 1, wherein the flexible connecting means is connected to the connection piece with an intermediate piece.

16. The voltage switchgear assembly as claimed in claim 14, wherein the flexible connecting means is integrally formed materially cohesively on the intermediate piece to form, with the intermediate piece, an integral unit.

17. The voltage switchgear assembly as claimed in claim 1, wherein
a connecting point between the connection piece and the connecting means is a cast connection.

18. The voltage switchgear assembly as claimed in claim 14, wherein
the connection piece is a hollow-cylindrical metallic component part, in which the hollow cylinder is parallel to a contact actuation axis, and the connecting means is arranged within the hollow cylinder and is connected to the hollow cylinder integrally and materially cohesively.

19. The voltage switchgear assembly as claimed in claim 14, wherein the connecting means comprises:
two connector strips arranged on diametrically opposite sides, attached centrally one above the other to the contact piece feed line of the moveable contact.

20. The voltage switchgear assembly as claimed in claim 19, wherein
the connector strips are flexible.
